(19) United States
(12) Patent Application Publication
(10) Pub. No.: US 2018/0210990 A1
(43) Pub. Date: Jul. 26, 2018

(54) LOGIC SIMULATION BASED LEAKAGE POWER CONTRIBUTOR MODELLING

(71) Applicant: INTERNATIONAL BUSINESS MACHINES CORPORATION, Armonk, NY (US)

(72) Inventors: Nagashyamala R. Dhanwada, Fishkill, NY (US); Arun Joseph, Bangalore (IN)

(21) Appl. No.: 15/414,017

(22) Filed: Jan. 24, 2017

(51) Int. Cl. G06F 17/50

(52) U.S. Cl. CPC G06F 17/5036

(57) ABSTRACT

A computer-implemented method for computing leakage power in a semiconductor device may include generating, via a processor, a process voltage temperature (PVT)-independent power model, generating, via the processor, a PVT-dependent power model based on the PVT-independent power model, and computing, via the processor, a leakage power based on the PVT-dependent power model.

### BACKGROUND

The present disclosure relates to power modeling for semiconductor devices, and more specifically, to logic simulation based leakage power contributor modeling

Power consumption is a key factor in the design of electronic products since it directly affects thermal margins, cost, and reliability. Increasing process variation in nanometer-scale devices complicates both power model and optimization. Complex power-aware design flows are being developed to address the challenges arising from increased design complexity while needing to keep power consumption under control. A need for accurate modeling is one reason for this complexity in the design flows.

The challenges in delivering accurate models can arise from variations at the device level and variations at the larger block and function level. Variation at the device level can come from the exponential dependence of power leakage on temperature and voltage. Variations at the larger block and function level can arise from power saving features like clock gating, power gating, and widely varying workload characteristics. Device level and function level variations lead to the challenges in current design flows. These challenges include significant increases in the characterization effort, distribution and maintenance of characterized data for cell libraries, significant impact on the memory footprint of library data (which can complicate power model tools that utilize characterization data), and increased turn-around time for completing the power leakage analysis tasks.

### SUMMARY

According to an embodiment of the present invention, a computer-implemented method for computing leakage power in a semiconductor device is described. The method may include generating, via a processor, a process voltage temperature (PVT)-independent power model, generating, via the processor, a PVT-dependent power model based on the PVT-independent power model, and computing, via the processor, a leakage power based on the PVT-dependent power model.

According to other embodiments, a system for computing leakage power in a semiconductor device is described. The system may include a processor configured to generate a process voltage temperature (PVT)-independent power model, generate a PVT-dependent power model based on the PVT-independent power model, and compute a leakage power based on the PVT-dependent power model.

According to yet other embodiments, a non-transitory computer-readable storage medium is described. The non-transitory storage medium may include program instructions that are executable by a processor to perform a method for computing leakage power in a semiconductor device. The method may include generating, via a processor, a process voltage temperature (PVT)-independent power model, generating, via the processor, a PVT-dependent power model based on the PVT-independent power model, and computing, via the processor, a leakage power based on the PVT-dependent power model.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a flow diagram of a conventional method for device modeling;

FIG. 2 depicts a block diagram of logic simulation based leakage power contributor modeling according to one embodiment;

FIG. 3 depicts a flow diagram of a method for modeling leakage power in a semiconductor device according to one embodiment;

FIG. 4 depicts a flow diagram of a method for generating a PVT-independent power model according to one embodiment;

FIG. 5 depicts a flow diagram of a method for generating a PVT-dependent power model according to one embodiment; and

FIG. 6 depicts a block diagram of a computer system for use in practicing the teachings herein.

### DETAILED DESCRIPTION

Power consumption can be a limiting factor in product design. For wireless devices, power consumption limits battery life and hence product appeal. For tethered devices, power consumption limits functionality due to constraints on heat generation and wall outlet power availability. Power consumption is also a major business and societal concern. For example, electronics applications, from home appliances to video games to enterprise data centers, now consume significant portions of the U.S. and world's total power supply.

The issues are equally daunting at the microelectronic level, as power consumption directly affects critical design parameters such as thermal margins, cost, and reliability. Complicating these issues is the additional complexity posed by process variation. Always a manufacturing issue, variation has dramatically increased in the nanometer era, complicating both power model and optimization.

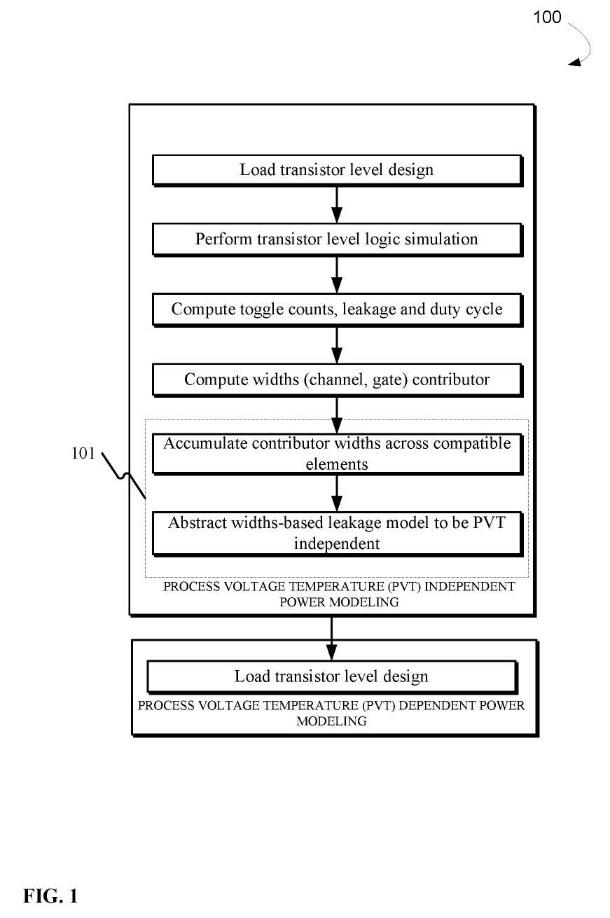

The response to these challenges has been the emergence of Power Aware Design (PAD) technologies, methodologies, and tools. PAD addresses not only the minimization of power consumption, known as “Low-Power Design,” but also the maximization of some other performance metric subject to a power budget. Typical PAD tasks include power specification, analysis, debugging, and optimization, in addition to the usual design tasks of system specification, simulation, verification, and physical design. PAD has also led to technologies such as power constraint languages CPF and UPF. These approaches require more accurate and extensive modeling methods and systems. As described with respect to FIG. 1, the state of the art modeling methods and apparatuses may result in undesirable errors when process, voltage, and temperature (“PVT”)-independent approaches are applied to power leakage analysis of nanometer-scale semiconductor devices.

Using conventional PVT independent modeling techniques in nanometer-scale devices (e.g., 14 nm or smaller) semiconductor devices often results in modeling errors. “PVT independent” means that, unlike traditional leakage models, the modeling technique can be used for computing leakage power for any process, voltage, or temperature corner.

The current state of the art power modeling standards does not efficiently support modeling of large IP blocks. Current power modeling techniques may utilize regression-based or table-based macro-modeling approaches. These macro models are parameterized on the structural aspects of the design and are based on techniques like regression analysis, hamming distance between input vectors, etc. All of these models store/compute power values for a given structural configuration for the macro. Conventional techniques (such as the technique depicted in FIG. 1) may use power model abstraction by the generation of power contributors (and not power values), thus making a conventional approach PVT independent.

A power contributor model contains all instance-independent information needed to model the power consumed by an instance of a particular cell, along with additional information that may be used to differentiate and identify different portions of the power consumption. Examples of which include: contact to device diffusion area, gate contact for power grid analysis, and latch vs. data power. In conventional techniques, evaluation of the model requires the application of instance-specific information like switching activities, voltages applied to power pins, switching frequency of clock pins, temperature, field effect transistor (FET) threshold variations, and process sigma.

While traditional power models directly reference energy and power data, they can utilize indirection through the use of contributors to reference either pre-characterized data or data characterized upon demand. Examples of simple power contributors include the channel or gate leakage of a single FET, the leakage of a FET stack, and the charging of a single node capacitance. The same contributors will generally appear in many library cell states.

The fundamental component of a power contributor model is a power element. A key feature of a power element is that it does not store power or energy numbers, instead stores the physical parameters (e.g., switching capacitance, resistances, current sources or effective leaking device width) that can be used to compute power at any process, temperature, and voltage condition. This makes the power model independent of switching activity, frequency, process, temperature, and voltage.

A second key feature of power elements is that they do not model the total power of a cell under a given condition. Instead, each power element of a model for a given cell type is evaluated for the process, temperature, voltage, and operating conditions (state and activity) of each design instance of that cell type and the contributions of all power elements are summed to determine the total power of the design instance. This summing of power contributor elements is a key concept that enables contributor based abstraction. Each power element has one or more “summable values” (e.g., capacitances for AC elements, and device widths and finger counts for leakage elements). In addition to power elements, the contributor model for a cell type may contain additional information such as the power supply pins of the cell providing power to each of its output net(s) and the load capacitance of each of its inputs.

After establishing a general background, by way of an example, we turn our attention now to one state-of-the-art power leakage modeling technique. Referring, now to FIG. 1, a flow diagram of a conventional device modeling technique (hereafter “conventional model 100”) is depicted using state of the art modeling techniques for modeling power leakage in semiconductor devices. Power contributor modeling enables generation of PVT-independent power models for higher level IP blocks. In conventional device modeling such as conventional model 100, a transistor-level design is loaded into memory, and a transistor-level logic simulation is performed. The transistor-level design can include, for example, data structures representing each transistor in a particular circuit. Logical patterns (simulations of input patterns) are input, and the processor maps the transistor-level design to a binary diagram. This step indicates how well the microelectronic circuit is functioning.

Next toggle counts are accumulated by the testing system processor. Here, toggle counts and leakage duty cycle are calculated, and the power contributors for a particular state of interest of a high-level IP block are identified by determining the states of its constituent cells and their power contributors in those states. For incompletely specified high-level IP states, state probabilities are determined for various possible states of its constituent cells (e.g., using probabilistic propagation or random simulation). The contributors for each of these cell states are then determined, and weighted by cell state probabilities (if needed) with power rail specifications mapped to those of the high level IP block.

Finally, in conventional model 100, toggle counts are accumulated, and width contributions are computed. Here, all compatible contributor instances are summed to form the aggregate list of contributors for the high-level IP block state. The simplest form of contributor summation accumulates a count (possibly fractional due to probabilistic weighting) of the instances of each power contributor. Contributor compatibility then requires that all parameters (e.g., device type/length/width and power rail references) be identical in contributor instances being summed. Alternatively, some parameter (e.g., device width) are treated in conventional methods as a “size” parameter for the contributor, summing these parameters for each set of compatible contributors instead of simply summing contributor counts. This works well if power is proportional to the chosen size parameter, but narrow channel effect causes a deviation from this for leakage. At the nanometer-scale, PVT independent power modeling breaks down using conventional model 100. This deviation becomes more pronounced (e.g., the error increases dramatically) when the device scale becomes smaller. For example, this error becomes pronounced in conventional methods in the step depicted in FIG. 1 at block 101. The smaller the technology, the more PVT-dependent the technology generally becomes (e.g., error margins may be over 3.5%).

Depending on the analysis condition, embodiments described herein can take in any of process, voltage or temperature characteristics as inputs, and construct a leakage power model with mitigated modeling error (e.g., with an error margin of 0.2-3.5%). Embodiments of the present invention provide a single PVT independent model that can be used for modeling leakage power for any semiconductor device operating condition, including nanometer-scale device.

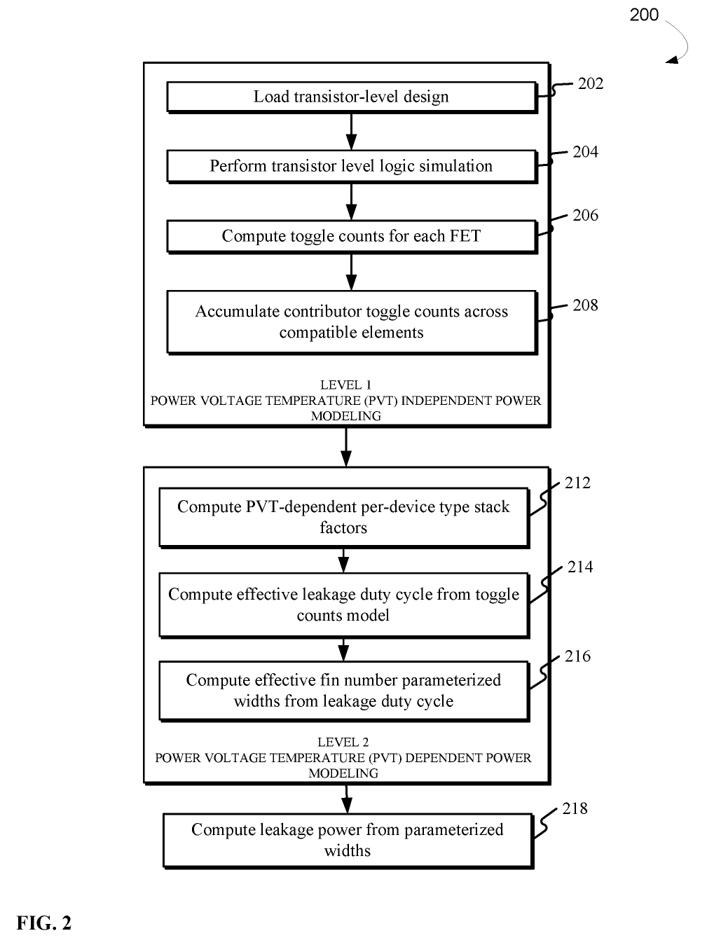

FIG. 2 depicts a block diagram of a method 200 of logic simulation based leakage power contributor modeling, according to one embodiment. Referring now to FIG. 2, a hierarchical approach to modeling leakage power is depicted. Hierarchical means, according to some embodiments, that the result of one or more modeling steps may be used for the following modeling steps. By comparison, as shown in FIG. 1, conventional methods are flat (not hierarchical in nature).

The hierarchical method depicted in FIG. 2 includes three main modeling steps that include a “Level 1” PVT-independent power modeling portion (that includes blocks 202-208), a “Level 2” PVT-dependent power modeling portion (that includes blocks 212-216) which uses modeling aspects from the PVT-independent portion, and a PVT-dependent power model portion (that includes block 218).

As shown in block 202, a system processor loads a transistor-level design into memory, and performs a transistor-level logic simulation, as shown in block 204. Accordingly, a system processor translates (maps) a circuit diagram to a binary diagram for a transistor-level binary simulation. From the transistor-level logic simulation, as shown in block 206, the processor computes toggle counts for each FET.

As shown in block 208, a system processor accumulates contributor toggle counts across compatible elements. For example, after a predetermined number of cycles (500 cycles, e.g.,) the processor determines how many times each transistor has toggled.

Blocks 202-208 depict level logic simulation steps that may include conventional modeling methods. In the Level 1 PVT-independent power modeling portion, the system performs a logic simulation (which is several orders of magnitude faster than circuit simulation) by simulating circuit at the transistor level. Accordingly, the system processor creates a leakage contributor model as an output of blocks 202-208. The leakage contributor model considers leakage mode factors, meaning that the system calculates and makes a determination of the factors contributing to the power leakage. In the Level 1 PVT-independent power modeling portion each of the contributors are evaluated to get leakage power by applying PVT factors, and the system determines the PVT independent sources of the leakage.

The Level 2 PVT-dependent power modeling portion includes block 212, where a system processor computes PVT-dependent per-device type stack factors. Each stack factor constant is PVT-dependent. There are different ways of stacking transistors. Stack factor is a fraction (<1) and captures the leakage power reduction obtained when a transistor is stacked as opposed to not being stacked. The stack factor can be computed using offline circuit simulation for each unique transistor type.

With PVT-dependent per-device type stack factors determined, the processor can now compute an effective leakage duty cycle from the toggle counts model, as shown in block 214. Using counts derived from the logic simulation steps 202-208, and PVT-dependent per-device type stack factors computed in block 212, the processor evaluates the leakage duty cycle.

As shown in block 216, the processor may compute the effective fin number parameterized widths from the leakage duty cycle. There could be several types of transistors (FETs) supported in the design, and each with its range of number of fingers (example, 3, 4, and 5). From each FET type, the system processor computes the leaking width. The leaking width is a function of the leakage duty cycle, and the raw width. Here, the raw width is a function of the width of a fin, the number of fins, and the number of fingers. Finally, as shown in block 218, the processor will use the parameterized widths to compute leakage power, as shown in block 218.

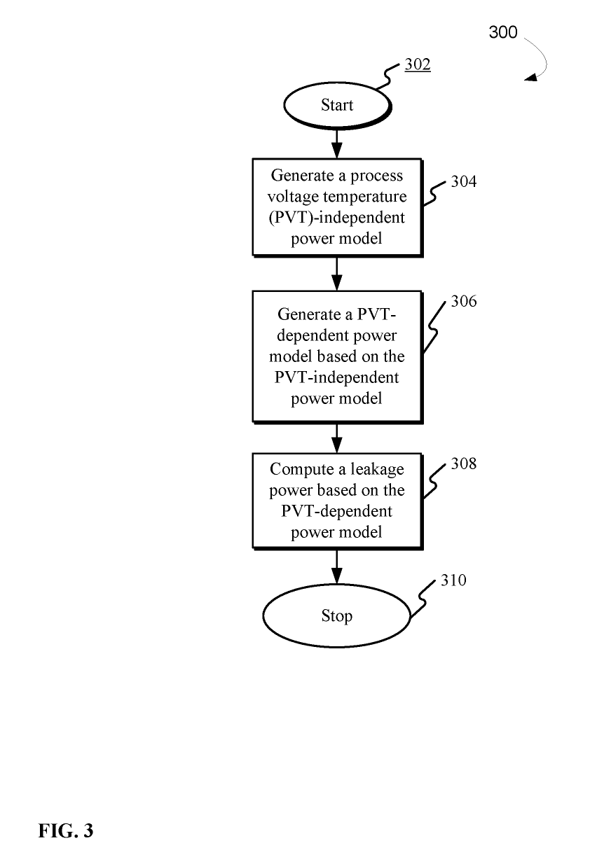

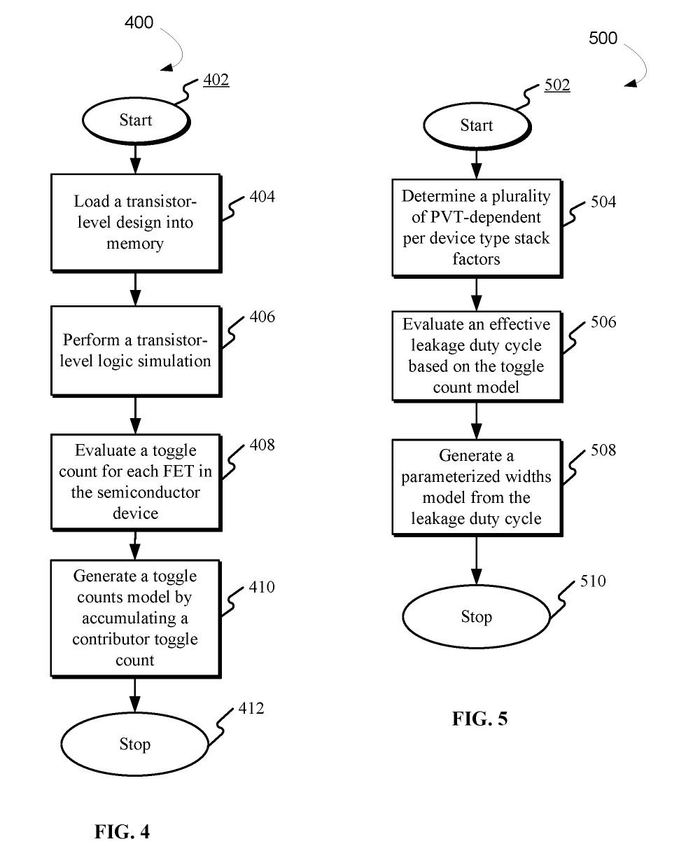

FIG. 3 depicts a flow diagram of a method 300 for modeling leakage power in a semiconductor device, according to one embodiment. Referring now to FIG. 3, in some aspects, after an initial start step 302, a system processor (e.g., processor 601 as shown in FIG. 6) may generate a process voltage temperature (PVT)-independent power model. In some aspects. FIG. 4 depicts a flow diagram of a method 400 for generating a PVT-independent power model, according to one embodiment.

Referring, briefly, to FIG. 4, in some non-limiting embodiments, processor 601 may generate the PVT-independent power model by loading, via processor 601, a transistor-level design. Accordingly, processor 601 may import a design from a circuit modeling utility (e.g., SPICE® or similar utility), and load the design to memory, as shown in block 404.

In some aspects, processor 601 may perform a transistor-level logic simulation, as depicted in block 406. Performing the transistor-level logic simulation may include performing a mapping of the circuit design to a binary map, and performing an analysis.

As shown in block 408, processor 601 may evaluate a toggle count for each FET in the semiconductor device, and generate a toggle counts model by accumulating a contributor toggle count, as shown in block 410. In one non-limiting embodiment, processor 601 may accumulate the contributor toggle count by accumulating the toggle count across a plurality of compatible elements. Compatible elements could include, for example, the same device type, the same rail, the same fin and the same finger count. Method 400 may conclude at stop step 412.

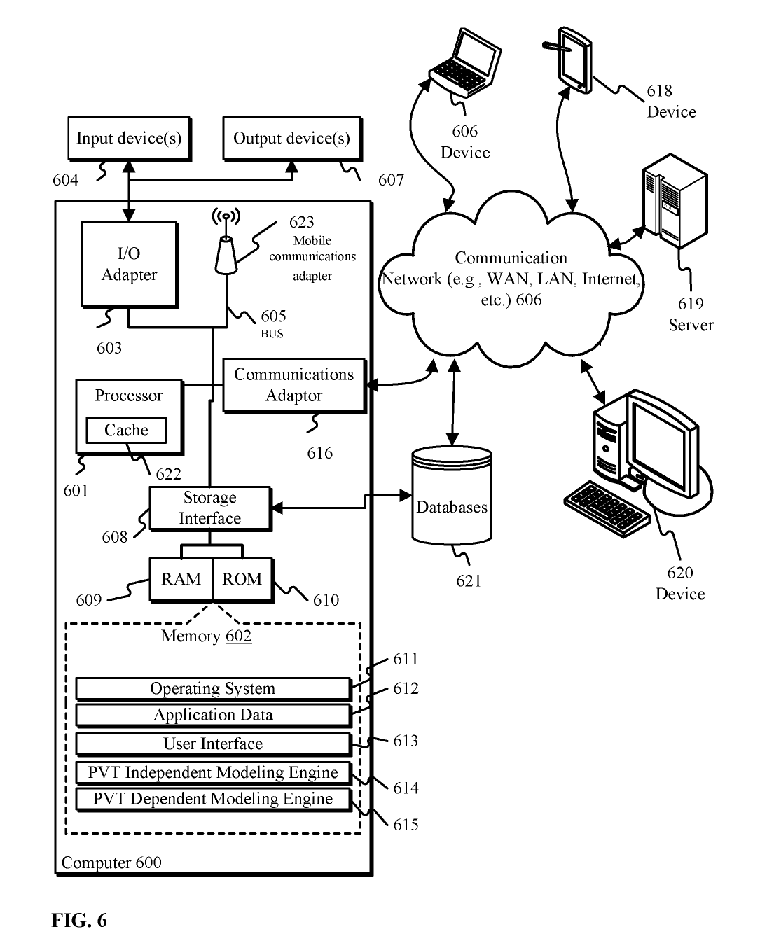

Referring, again, to FIG. 3, after generating a PVT-independent power model at step 304, processor 601 may generate a PVT-dependent power model based on the PVT-independent power model, as shown in block 306. FIG. 5 depicts a flow diagram of a method 500 for generating a PVT-dependent power model, according to one embodiment.

Referring briefly to FIG. 5, processor 601 may generate the PVT-dependent power model by determining, via processor 601, a plurality of PVT-dependent per device type stack factors, as shown in block 504. As depicted in block 506, processor 601 may evaluate an effective leakage duty cycle based on the toggle count model, and generate via the processor, a parameterized widths model from the leakage duty cycle, as shown in block 508. Method 500 may stop at step 510.

Referring once again to FIG. 3, after generating, via processor 601, a PVT-dependent power model based on the PVT-independent power model as depicted in FIG. 5, processor 601 may compute a leakage power based on the PVT-dependent power model, as shown in block 308. In some aspects, the leakage power is indicative of an effective number of fins parameterized widths. Method 300 concludes at step 310.

Embodiments described herein can result in a reduced circuit characterization effort, a significant reduction in the distribution and maintenance of characterized data for cell libraries, and provide a significant reduction to the turn-around time for completing the power leakage analysis tasks. Moreover, at the nanometer-scale, PVT independent power modeling using embodiments described herein may significantly decrease error when the device scale becomes smaller. For example, error margins may be reduced to less than 3.5% when used for leakage power modeling for devices at the 14 nm scale or smaller.

The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer.

FIG. 6 illustrates a block diagram of an exemplary computing environment and computer system 600 (hereafter “computer 600”) for use in practicing the embodiments described herein. In an exemplary embodiment, in terms of hardware architecture, as shown in FIG. 6, computer 600 includes processor 601. Computer 600 also includes memory 602 coupled to processor 601, and one or more input/output adapters 603 that may be communicatively coupled via system bus 605. Memory 602 may be operatively coupled to one or more internal or external memory devices via a storage interface 608. Communications adapter 616 may be operatively connect computer 600 to one or more networks 606. System bus 605 may connect one or more user interfaces via input/output (I/O) adapter 603. I/O adapter 603 may connect a plurality of input devices 604 to computer 600. Input devices may include, for example, a keyboard, a mouse, a microphone, a sensor, etc. System bus 605 may also connect one or more output devices 607 via I/O adapter 603. Output device 607 may include, for example, a display, a speaker, a touchscreen, etc.

Processor 601 is a hardware device for executing hardware instructions or software, particularly that stored in a non-transitory computer-readable memory (e.g., memory 602). Processor 601 can be any custom made or commercially available processor, a central processing unit (CPU), a plurality of CPUs, for example, CPU 601a-601c, an auxiliary processor among several other processors associated with the computer 600, a semiconductor based microprocessor (in the form of a microchip or chip set), or generally any device for executing instructions. Processor 601 can include a cache memory 622, which may include, but is not limited to, an instruction cache to speed up executable instruction fetch, a data cache to speed up data fetch and store, and a translation lookaside buffer (TLB) used to speed up virtual-to-physical address translation for both executable instructions and data. Cache memory 622 may be organized as a hierarchy of more cache levels (L1, L2, etc.).

Processor 601 may be disposed in communication with one or more memory devices (e.g., RAM 609, ROM 610, one or more external databases 621, etc.) via a storage interface 608. Storage interface 608 may also connect to one or more memory devices including, without limitation, one or more databases 621, and/or one or more other memory drives (not shown) including, for example, a removable disc drive, etc., employing connection protocols such as serial advanced technology attachment (SATA), integrated drive electronics (IDE), IEEE-1394, universal serial bus (USB), fiber channel, small computer systems interface (SCSI), etc. The memory drives may be, for example, a drum, a magnetic disc drive, a magneto-optical drive, an optical drive, a redundant array of independent discs (RAID), a solid-state memory device, a solid-state drive, etc.

Memory 602 can include random access memory (RAM) 609 and read only memory (ROM) 610. RAM 609 can be any one or combination of volatile memory elements (e.g., DRAM, SRAM, SDRAM, etc.). ROM 610 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 602 may incorporate electronic, magnetic, optical, and/or other types of non-transitory computer-readable storage media. Memory 602 may also be a distributed architecture, where various components are situated remote from one another, but can be accessed by processor 601.

The instructions in memory 602 may include one or more separate programs, each of which comprises an ordered listing of computer-executable instructions for implementing logical functions. In the example of FIG. 6, the instructions in memory 602 may include an operating system 611. Operating system 611 can control the execution of other computer programs and provides scheduling, input-output control, file and data management, memory management, and communication control and related services.

The instructions in memory 602 may further include application data 612, and a user interface 613.

Memory 602 may also include PVT independent modeling engine 614, configured to receive a transistor-level design and load the design into memory 602, perform a transistor-level logic simulation, evaluate a toggle count for each FET in a semiconductor device model, and generate a toggle counts model by accumulating a contributor toggle count.

Memory 602 may further include PVT dependent modeling engine 615, which may be configured to Determine a plurality of PVT-dependent per device type stack factors, evaluate an effective leakage duty cycle based on the toggle count model, and generate a parameterized widths model from the leakage duty cycle.

I/O adapter 603 can be, for example but not limited to, one or more buses or other wired or wireless connections. I/O adapter 603 may have additional elements (which are omitted for simplicity) such as controllers, microprocessors, buffers (caches), drivers, repeaters, and receivers, which may work in concert to enable communications. Further, I/O adapter 603 may facilitate address, control, and/or data connections to enable appropriate communications among the aforementioned components.

I/O adapter 603 can further include a display adapter coupled to one or more displays. I/O adapter 603 may be configured to operatively connect one or more input/output (I/O) devices 607 to computer 600. For example, I/O 603 may connect a keyboard and mouse, a touchscreen, a speaker, a haptic output device, or other output device. Output devices 607 may include but are not limited to a printer, a scanner, and/or the like. Other output devices may also be included, although not shown. Finally, the I/O devices connectable to I/O adapter 603 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

According to some embodiments, computer 600 may include a mobile communications adapter 623. Mobile communications adapter 623 may include GPS, cellular, mobile, and/or other communications protocols for wireless communication.

In some embodiments, computer 600 can further include communications adapter 616 for coupling to a network 606.

Network 606 can be an IP-based network for communication between computer 600 and any external device. Network 606 transmits and receives data between computer 600 and devices and/or systems external to computer 600. In an exemplary embodiment, network 606 can be a managed IP network administered by a service provider. Network 606 may be a network internal to an aircraft, such as, for example, an avionics network, etc. Network 606 may be implemented in a wireless fashion, e.g., using wireless protocols and technologies, such as WiFi, WiMax, etc. Network 606 may also be a wired network, e.g., an Ethernet network, an ARINC 429 network, a controller area network (CAN), etc., having any wired connectivity including, e.g., an RS232 connection, R5422 connection, etc. Network 606 can also be a packet-switched network such as a local area network, wide area network, metropolitan area network, Internet network, or other similar type of network environment. The network 606 may be a fixed wireless network, a wireless local area network (LAN), a wireless wide area network (WAN) a personal area network (PAN), a virtual private network (VPN), intranet or other suitable network system.

Network 606 may operatively connect computer 600 to one or more devices including device 617, device 618, and device 620. Network 606 may also connect computer 600 to one or more servers such as, for example, server 619.

If computer 600 is a PC, workstation, laptop, tablet computer and/or the like, the instructions in the memory 602 may further include a basic input output system (BIOS) (omitted for simplicity). The BIOS is a set of essential routines that initialize and test hardware at startup, start operating system 611, and support the transfer of data among the operatively connected hardware devices. The BIOS is stored in ROM 610 so that the BIOS can be executed when computer 600 is activated. When computer 600 is in operation, processor 601 may be configured to execute instructions stored within the memory 602, to communicate data to and from the memory 602, and to generally control operations of the computer 600 pursuant to the instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for modeling leakage power in a semiconductor device comprising:
generating, via a processor, a process voltage temperature (PVT)-independent power model;
generating, via the processor, a PVT-dependent power model based on the PVT-independent power model; and
computing, via the processor, a leakage power based on the PVT-dependent power model.

2. The computer-implemented method of claim 1, wherein generating the PVT-independent power model comprises:
loading, via the processor, a transistor-level design;
performing, via the processor, a transistor-level logic simulation;
evaluating, via the processor, a toggle count for each FET in the semiconductor device; and
generating, via the processor, a toggle counts model by accumulating a contributor toggle count.

3. The computer-implemented method of claim 2, wherein accumulating the contributor toggle count comprises accumulating the toggle count across a plurality of compatible elements.

4. The computer-implemented method of claim 3, wherein the plurality of compatible elements comprise a same device type, a same rail, a same fin and a same finger count.

5. The computer-implemented method of claim 2, wherein generating the PVT-dependent power model comprises:
determining, via the processor, a plurality of PVT-dependent per device type stack factors;
evaluating, via the processor, an effective leakage duty cycle based on the toggle counts model; and
generating, via the processor, a parameterized widths model from the leakage duty cycle.

6. The computer-implemented method of claim 5, wherein the parameterized widths model is indicative of an effective number of fins parameterized widths.

7. The computer-implemented method of claim 5, further comprising:
computing a leakage power from an effective number of fins parameterized widths.

8. A system for modeling leakage power in a semiconductor device comprising:
a processor configured to:
generate a process voltage temperature (PVT)-independent power model;
generate a PVT-dependent power model based on the PVT-independent power model; and
compute a leakage power based on the PVT-dependent power model.

9. The system of claim 8, wherein generating the PVT-independent power model comprises:
loading, via the processor, a transistor-level design;
performing, via the processor, a transistor-level logic simulation;
evaluating, via the processor, a toggle count for each FET in the semiconductor device; and
generating, via the processor, a toggle counts model by accumulating a contributor toggle count.

10. The system of claim 9, wherein accumulating the contributor toggle count comprises accumulating the toggle count across a plurality of compatible elements.

11. The system of claim 10, wherein the plurality of compatible elements comprise a same device type, a same rail, a same fin and a same finger count.

12. The system of claim 9, wherein generating the PVT-dependent power model comprises:
determining, via the processor, a plurality of PVT-dependent per device type stack factors;
evaluating, via the processor, an effective leakage duty cycle based on the toggle counts model; and
generating, via the processor, a parameterized widths model from the leakage duty cycle.

13. The system of claim 12, wherein the parameterized widths model is indicative of an effective number of fins parameterized widths.

14. The system of claim 12, further comprising:
computing a leakage power from an effective number of fins parameterized widths.

15. A computer program product for modeling leakage power in a semiconductor device, the computer program product comprising a computer readable storage medium having program instructions embodied therewith, the program instructions executable by a processor to cause the processor to perform a method comprising:
generating a process voltage temperature (PVT)-independent power model;
generating a PVT-dependent power model based on the PVT-independent power model; and
computing a leakage power based on the PVT-dependent power model.

16. The computer program product of claim 15, wherein generating the PVT-independent power model comprises:
loading a transistor-level design;
performing a transistor-level logic simulation;
evaluating a toggle count for each FET in the semiconductor device; and
generating a toggle counts model by accumulating a contributor toggle count.

17. The computer program product of claim 16, wherein accumulating the contributor toggle count comprises accumulating the toggle count across a plurality of compatible elements.

18. The computer program product claim 17, wherein the plurality of compatible elements comprise a same device type, a same rail, a same fin and a same finger count.

19. The computer program product of claim 16, wherein generating the PVT-dependent power model comprises:
determining a plurality of PVT-dependent per device type stack factors;
evaluating an effective leakage duty cycle based on the toggle count model; and
generating a parameterized widths model from the leakage duty cycle.

20. The computer program product of claim 19, wherein the parameterized widths model is indicative of an effective number of fins parameterized widths.
